(19) United States
(12) Patent Application Publication
(10) Pub. No.: US 2016/0124841 A1
(43) Pub. Date: May 5, 2016

(54) INFORMATION PROCESSING SYSTEM AND DATA PROCESSING METHOD

(71) Applicant: HITACHI, LTD., Tokyo (JP)

(72) Inventors: Takumi NITO, Tokyo (JP); Yoshiko NAGASAKA, Tokyo (JP); Hiroshi UCHIGAITO, Tokyo (JP)

(73) Assignee: HITACHI, LTD., Tokyo (JP)

(21) Appl. No.: 14/892,224

(22) PCT Filed: Jun. 6, 2013
(86) PCT No.: PCT/JP2013/065696

§ 371 Date: Nov. 19, 2015

(51) Int. Cl. G06F 12/02

(52) U.S. Cl. CPC G06F 12/0238; G06F 2212/202

(57) ABSTRACT

The information processing apparatus includes a preprocessing unit that allocates the identifier to one or more collected groups, the main storage unit including a buffer having a size of the predetermined unit installed for each group, the storage unit that stores the data written in the buffer for each predetermined unit and each group, a write processing unit that acquires the data allocated to the group for each group and writes the acquired data in the buffer, determines whether or not the data of the predetermined unit has been written in the buffer, and causes the storage unit to store the data written in the buffer when the data of the predetermined unit is determined to have been written in the buffer, and a read processing unit that reads the stored data out to the main storage unit for each group, extracts the read data, and executes the process.

### TECHNICAL FIELD

The present invention relates to an information processing system, and more particularly, to efficient access to a storage, particularly, a non-volatile memory.

### BACKGROUND ART

A recording density has increased with the development of a communication technique such as the Internet and the improvement of a storage technique, a data amount with which companies or individuals deal has been significantly increased, and thus recently, analyzing a connection (which is also referred to as a “network”) of large-scale data has become important. Particularly, in a connection of data occurring in the natural world, many graphs have a characteristic called scale free, and analyzing a large-scale graph having a scale-free characteristic has become important (Patent Document 1).

The graph is configured with a vertex and an edge as illustrated in FIG. 1, and each of the edge and the vertex can have a value. The number of edges per vertex is referred to as a degree, and in the graph having the scale-free characteristic, an existence probability of vertices of each degree has a power-law distribution. In other words, a degree has the largest number of vertices, and as the degree increases, the number of vertices decreases. Since the large-scale graph having the scale-free characteristic is different from a distribution having a uniform structure, in this analysis, random access having fine granularity to data occurs extremely frequently, unlike a matrix calculation that is commonly used in a scientific calculation or the like.

As a representative graph analysis technique, there is a graph process using a bulk synchronous parallel (BSP) model (Non-Patent Document 1). In this technique, each vertex performs a calculation based on a value of its own vertex, a value of a connected edge, a vertex connected by an edge, and a message transmitted to a vertex, and transmits a message to another vertex according to a calculation result. A process is delimited in synchronization with each calculation of each vertex, and the delimiting is referred to as a “superstep.” The process is performed by repeating the superstep.

### CITATION LIST

### Patent Document

Patent Document 1: JP 2004-318884 A

### Non-Patent Document

Non-Patent Document 1: Grzegorz Malewicz, Pregel: A System for Large-Scale Graph Processing, PODC'09, Aug. 10-13, 2009, Calgary, Alberta, Canada. ACM978-1-60558-396-9/09/08.

### SUMMARY OF THE INVENTION

### Problems to be Solved by the Invention

In the graph process using the BSP model, it is necessary to store a message transmitted at a certain superstep until the message is used for a calculation in a next superstep. The message and graph data (for example, data of a vertex ID, a value, a vertex ID of a vertex connected by an edge, and a value of an edge are associated as illustrated in FIG. 2) do not enter a main storage of a computer when the size of the graph is increased. In this regard, the message and the graph data are stored in a large-capacity non-volatile memory and read from a non-volatile memory to a main storage as necessary for a calculation. However, the non-volatile memory is a block device and has a problem in that performance is lowered when there is access of granularity smaller than a minimum access unit (a page size) of the non-volatile memory, and in the graph process, such random access having fine granularity occurs frequently.

The present invention was made in light of the foregoing, and it is an object of the present invention to provide an information processing system and a data processing method in which random access having fine granularity does not occur frequently.

### Solutions to Problems

In order to solve the above problem and achieve the above object, an information processing system according to the present invention causes an information processing apparatus including a main storage unit and a storage unit capable of reading and writing data including an identifier in predetermined units to collect and process the data by a predetermined amount, and the information processing apparatus includes a preprocessing unit that allocates the identifier to one or more collected groups, the main storage unit including a buffer having a size of the predetermined unit installed for each group, the storage unit that stores the data written in the buffer for each predetermined unit and each group, a write processing unit that acquires the data allocated to the group for each group and writes the acquired data in the buffer, determines whether or not the data of the predetermined unit has been written in the buffer, and causes the storage unit to store the data written in the buffer when the data of the predetermined unit is determined to have been written in the buffer, and a read processing unit that reads the stored data out to the main storage unit for each group, extracts the read data, and executes the process.

Further, the present invention provides a data processing method performed by the information processing system.

### Effects of the Invention

According to the present invention, it is possible to provide an information processing system and a data processing method in which random access having fine granularity does not occur frequently.

### BRIEF DESCRIPTION OF THE DRAWINGS

FIG. 1 is a diagram illustrating an exemplary configuration of a general graph.

FIG. 2 is a diagram illustrating an exemplary configuration of general graph data.

FIG. 3 is a diagram illustrating an exemplary physical configuration of an information processing system.

FIG. 4A is a block diagram illustrating a functional configuration of a server device.

FIG. 4B is a diagram illustrating an exemplary configuration of graph data according to the present embodiment.

FIG. 5A is a conceptual diagram illustrating an example in which a vertex value is written in a non-volatile memory.

FIG. 5B is a conceptual diagram illustrating an example in which adjacency information is written in a non-volatile memory.

FIG. 6 is a conceptual diagram illustrating an example in which a message is written in a non-volatile memory.

FIG. 7 is a conceptual diagram illustrating an example in which a message is read from non-volatile memory.

FIG. 8 is a conceptual diagram illustrating an example in which a message is sorted.

FIG. 9A is a diagram illustrating an example of a method of writing a key-value pair in a non-volatile memory.

FIG. 9B is a diagram illustrating an example of a method of reading a key-value pair from a non-volatile memory in a sorting phase.

FIG. 10 is a flowchart illustrating a procedure of a graph process performed by the present system.

FIG. 11 is a flowchart illustrating a procedure of a graph data NVM writing process.

FIG. 12 is a flowchart illustrating a procedure of an NVM reading process.

FIG. 13 is a flowchart illustrating a procedure of a sorting process.

FIG. 14 is a flowchart illustrating a procedure of a calculation/message transmission process.

FIG. 15 is a flowchart illustrating a procedure of a message reception/NVM writing process.

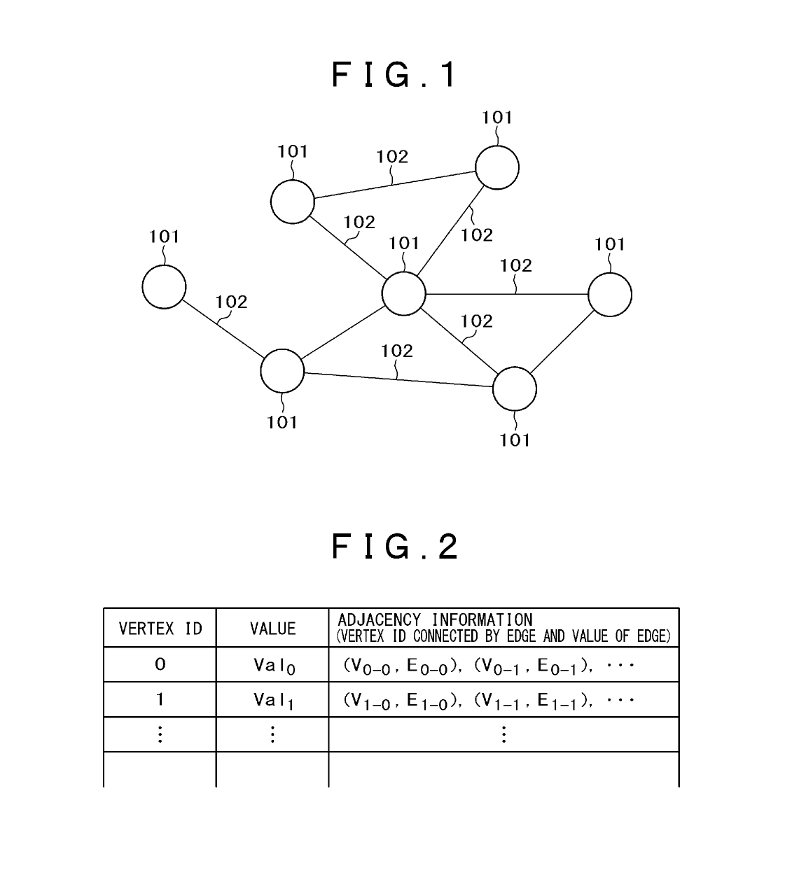

### MODE FOR CARRYING OUT THE INVENTION

Hereinafter, an embodiment of an information processing system and a data processing method according to the present invention will be described in detail with reference to the appended drawings. Hereinafter, there are cases in which a non-volatile memory is abbreviated as an NVM.

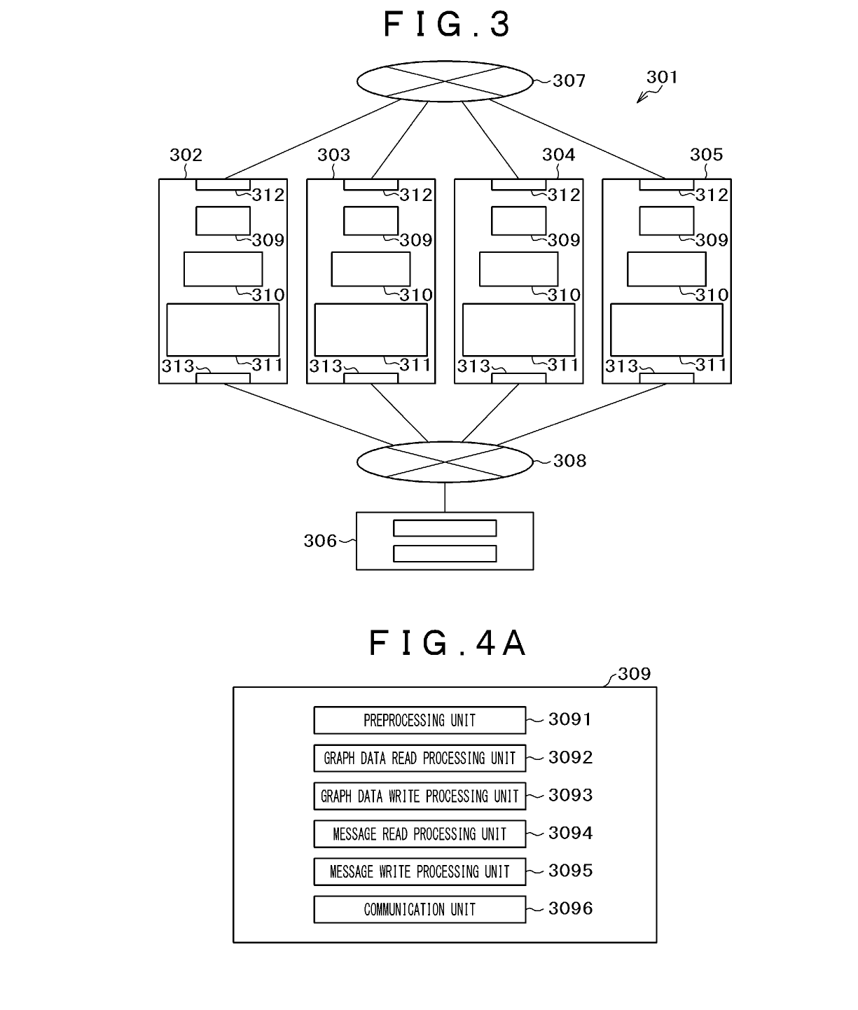

FIG. 3 is a diagram illustrating an exemplary physical configuration of an information processing system 301 according to an embodiment of the present invention. As illustrated in FIG. 3, in the information processing system 301, server devices 302 to 305 are connected with a shared storage device 306 via a network 307 and a storage area network 308. The following description will proceed with an example in which the number of server devices is 4, but the number of server devices is not limited. Each of the server devices 302 to 305 includes a CPU 309, a main storage 310, a non-volatile memory 311 serving as a local storage device, a network interface 312, and a storage network interface 313. The present embodiment will be described in connection with an example in which the main storage 310 is a DRAM, and the non-volatile memory 311 is a NAND flash memory, but can be applied to various storage media. The non-volatile memory 311 is a block device, and performance is lowered when random access of granularity smaller than a block size is performed. In the present embodiment, the block size of the non-volatile memory 311 is 8 KB. As will be described later, graph data that is stored in the shared storage device 306 in advance is divided into groups of the server devices 302 to 305, and a graph process of graph data sorted by each server device is performed according to the BSP model.

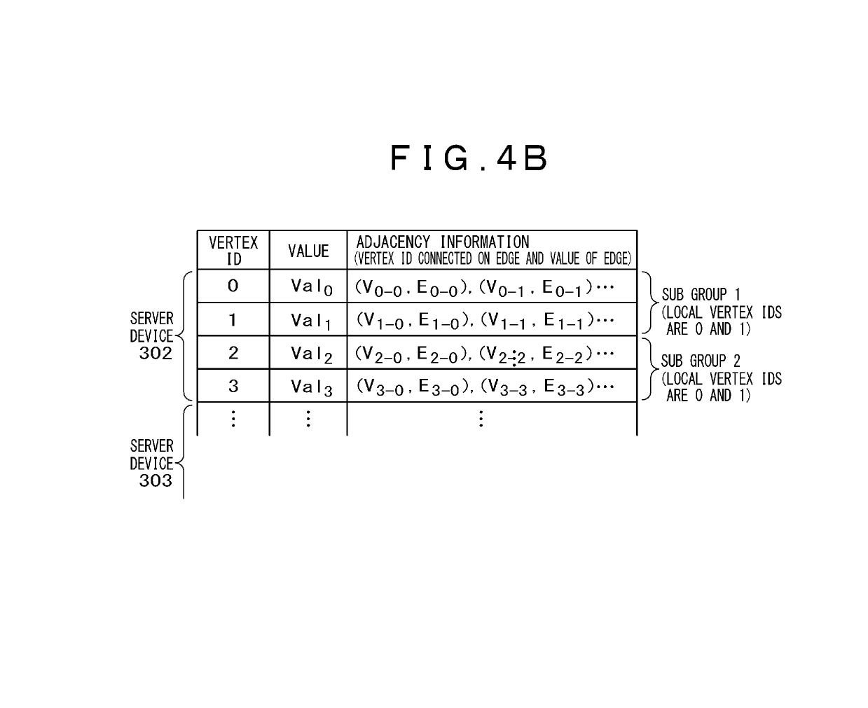

FIG. 4A is a block diagram illustrating a functional configuration of the server device of each of the server devices 302 to 305 and the shared storage device 306. As illustrated in FIG. 4A, each of the server devices includes a preprocessing unit 3091, a graph data read processing unit 3092, a graph data write processing unit 3093, a message read processing unit 3094, a message write processing unit 3095, and a communication unit 3096.

The preprocessing unit 3091 decides a server device that performs a graph process for all vertices, groups the vertices according to each server device, allocates and defines a plurality of collected sub groups in order to further collect a predetermined amount and perform a calculation, and associates a local vertex ID to a vertex within each of sub groups. The graph data read processing unit 3092 reads the graph data from the shared storage device 306, and transmits data of each vertex of the graph data to a server device that performs a process decided by the preprocessing unit 3091 through the communication unit 3096. The graph data write processing unit 3093 receives the transmitted graph data through the communication unit 3096, and writes the graph data in the non-volatile memory 311.

The message read processing unit 3094 performs a process of a superstep for a vertex (identifier) allocated to each server device, and transmits a message to another vertex through the communication unit 3096 according to the result. The message write processing unit 3095 receives the message transmitted from each server device to which another vertex is allocated through the communication unit 3096, and writes the message in the non-volatile memory 311. The communication unit 3096 performs transmission and reception of various kinds of information such as the message or the graph data with another server device. Specific processes performed by the above components will be described later using a flowchart.

FIG. 4B is a diagram illustrating an example of graph data of each of server devices divided into groups and sub groups. As illustrated in FIG. 4B, the graph data is stored such that a vertex ID serving as a transmission destination of a message and a value (a vertex value) thereof are associated with adjacency information (a vertex ID of a vertex connected with the vertex by an edge and a value of the edge). As understood in the example illustrated in FIG. 4B, a vertex value of a vertex whose vertex ID is “0” is “Val₀,” and a vertex value included in the adjacency information and a value of an edge connected with the vertex is (V₀₋₀, E₀₋₀), (V₀₋₁, E₀₋₁) . . . . The vertices are grouped according to each server device, and a vertex and a group to which a vertex belongs are understood. For example, it is indicated that vertices whose vertex IDs are “0” to “3” undergo the graph process performed by the server device 302. Further, the vertices are divided into sub groups in order to perform a calculation, and for example, it is indicated that vertices whose the vertex IDs are “0” and “1” belong to a sub group 1. For the vertices belonging to the sub group 1, a local vertex ID is decided as an ID for identifying a vertex within the sub group. For example, it is indicated that the vertices whose the vertex IDs are “0” and “1” belong to the sub group 1, and have the local vertex IDs of “0” and “1.” Further, it is indicated that the vertices whose the vertex IDs are “2” and “3” belong to a sub group 2, and have the local vertex IDs of “0” and “1.” A message is transmitted and received in association with the vertex ID.

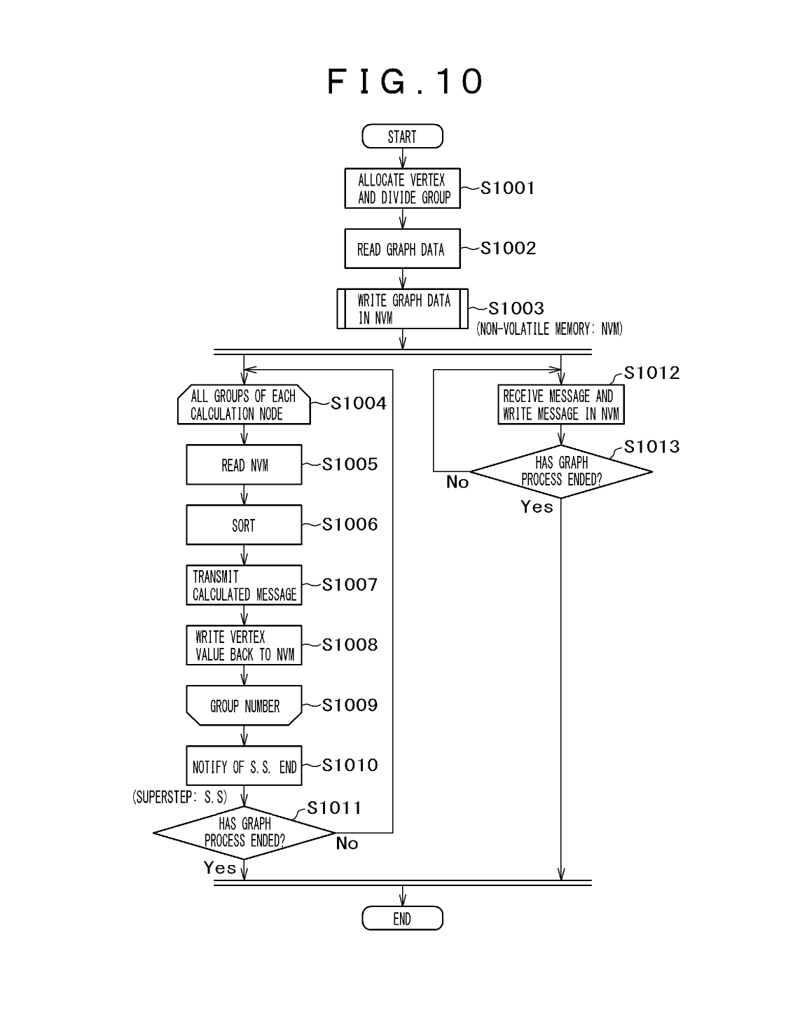

FIG. 10 is a flowchart illustrating a procedure of a graph process performed by the present system. As illustrated in FIG. 10, in the graph process, first, the preprocessing unit 3091 divides all graph data serving as a graph process target into a plurality of groups by the number of server devices as illustrated in FIG. 4B, and decides vertices that are calculated by the server devices 302 to 305. At this time, the graph data of each grouped server device is further collected by a predetermined amount, and a plurality of collected groups (sub groups) are defined in order to perform a calculation. As a method of defining a sub group, the number of vertices included in a sub group is set so that an amount of the graph data of the vertices included in the sub group and the messages destined to the vertices included in the sub group is sufficiently larger than the page size (a predetermined unit) serving as a minimum access unit of the non-volatile memory 311 and smaller than the capacity of the main storage 310. IDs (local vertex IDs) of local vertices having a serial number starting from 0 are allocated to the vertices of each sub group. (step S1001) The graph data read processing unit 3092 reads the graph data from the shared storage device 306, and transmits data of each vertex of the graph data to the server device that calculates of the vertex (step S1002).

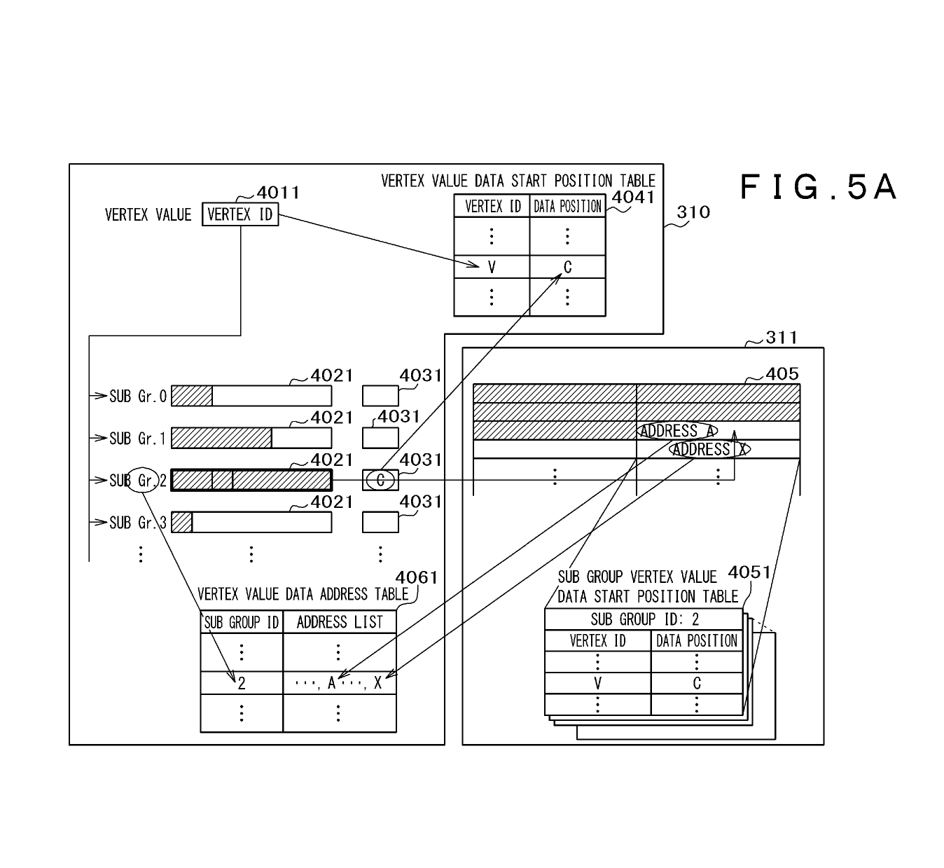

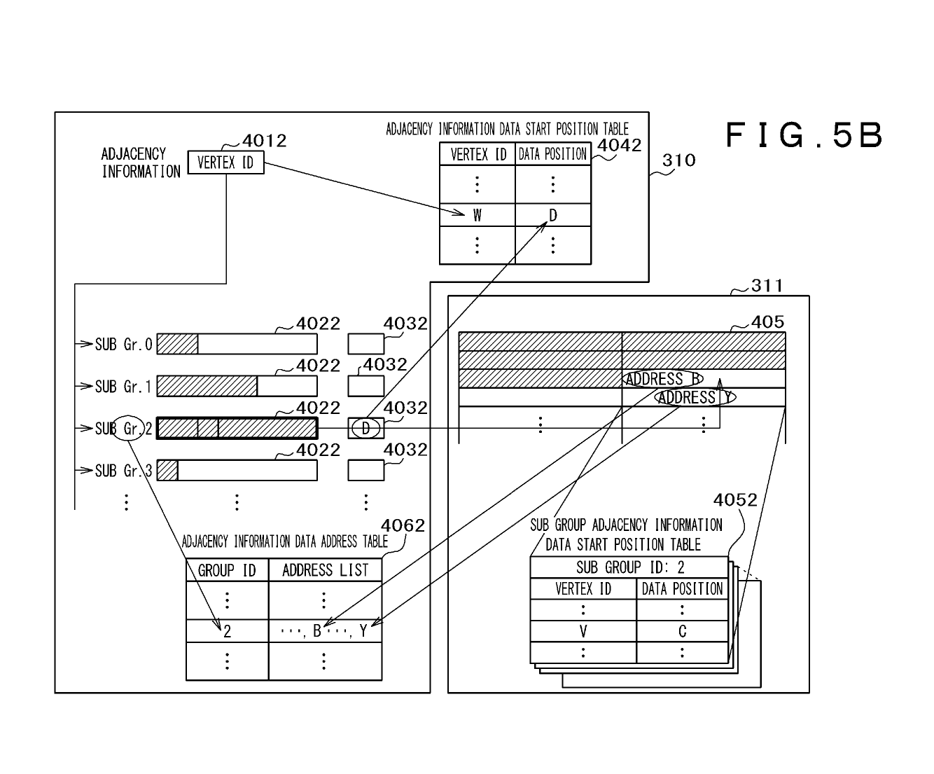

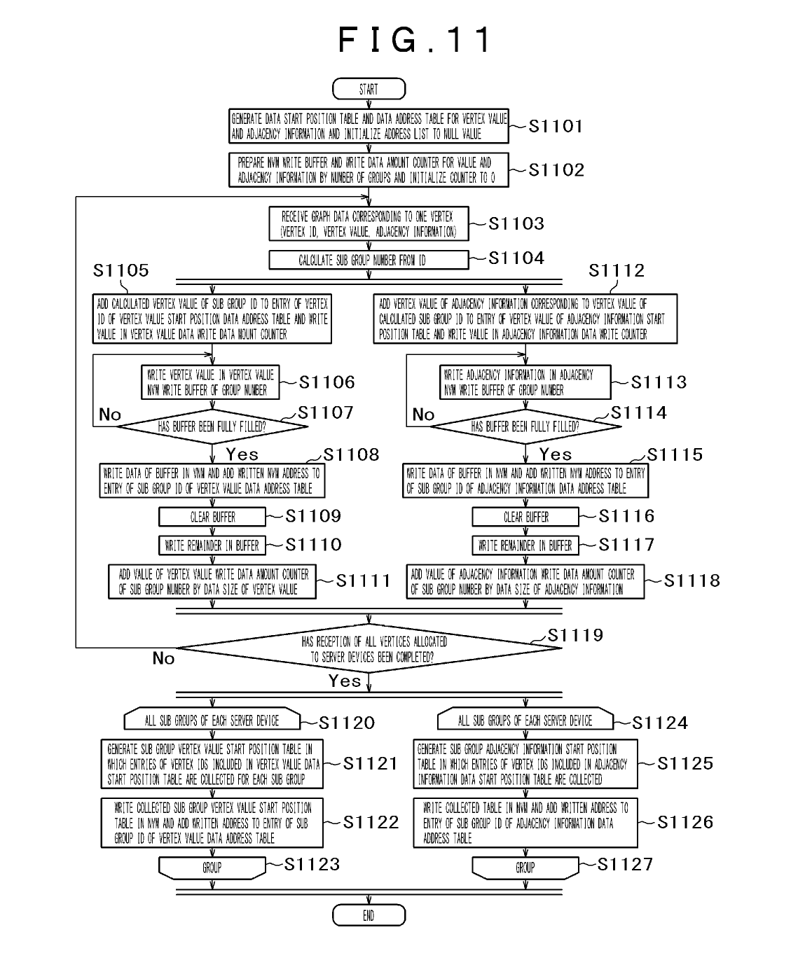

Then, upon receiving the graph data, the graph data write processing unit 3093 executes the graph data NVM writing process (step S1003). FIG. 11 is a flowchart illustrating a procedure of the graph data NVM writing process. As illustrated in FIG. 11, the message transmission processing unit 3091 of each server device first generates data start position tables (a vertex value data start position table and a adjacency information data start position table) for the vertex value and the adjacency information illustrated in FIGS. 5A and 5B and data address tables (a vertex value data address table and a adjacency information data address table) having entries corresponding to the number of groups, and initializes an address list of each entry of the data address table to a null value (step S1101).

For example, as illustrated in FIGS. 5A and 5B, the graph data write processing unit 3093 generates a vertex value data start position table 4041 in which a local vertex ID is associated with a data position serving as a write start position of a vertex value of the local vertex ID. Further, the graph data write processing unit 3093 generates a adjacency information data start position table 4042 in which a vertex ID is associated with a data position serving as a write start position of a vertex value of the vertex ID. Furthermore, the graph data write processing unit 3093 generates a vertex value data address table 4061 indicating an address at which data of a vertex value non-volatile memory write buffer 4021 (which will be described later) is written in a non-volatile memory 405 when the vertex value non-volatile memory write buffer 4021 is fully filled. Similarly, the graph data write processing unit 3093 generates adjacency information data address table 4062 indicating an address at which data of a adjacency information non-volatile memory write buffer 4022 (which will be described later) is written in the non-volatile memory 405 when the adjacency information non-volatile memory write buffer 4022 is fully filled.

Further, the graph data write processing unit 3093 of each server device generates non-volatile memory write buffers (a vertex value non-volatile memory write buffer and adjacency information non-volatile memory write buffer) and write data amount counters (a vertex value write data amount counter and a adjacency information write data amount counter) for the vertex value and the adjacency information, and initializes the write data amount counters to zero (step S1102).

For example, as illustrated in FIGS. 5A and 5B, the graph data write processing unit 3093 generates the vertex value non-volatile memory write buffer 4021 for reading and writing data obtained by collecting the vertex values between the main storage 310 and the non-volatile memory 405 by the page size by the number of sub groups. Similarly, the graph data write processing unit 3093 generates the adjacency information non-volatile memory write buffer 4022 for reading and writing data obtained by collecting the vertex values of the adjacency information between the main storage 310 and the non-volatile memory 405 by the page size by the number of sub groups.

The graph data write processing unit 3093 generates a vertex value write data amount counter 4031 by the number of sub groups that are counted up by a written data amount. Similarly, the graph data write processing unit 3093 generates a adjacency information write data amount counter 4032 by the number of sub groups that are counted up by a written data amount.

Thereafter, the graph data write processing unit 3093 of each server device receives the vertex ID, the vertex value, and the adjacency information corresponding to one vertex from the transmitted graph data (step S1103), and calculates a group ID of a sub group to which the read vertex ID, the vertex value, and the adjacency information corresponding to one vertex from the vertex ID belong (step S1104).

The graph data write processing unit 3093 of each server device adds the entry of the vertex ID to the vertex data start position table 4041, writes the value of the vertex write data amount counter 4031 of the calculated sub group ID (step S1105), and writes the vertex value in the vertex value non-volatile memory write buffer 4031 of the calculated sub group ID (step S1106). In FIG. 5A, for example, when the graph data write processing unit 3093 writes the vertex value in the vertex value non-volatile memory write buffer 4021, the graph data write processing unit 3093 stores a vertex ID “V” and a data position serving as the write start position of the vertex ID (that is, a count value of the vertex value write data amount counter 4031) “C” in the vertex value data start position table 4041 in association with each other. The count value “C” indicates that the sub group belongs to “2,” and the vertex value write data amount counter 4031 is counted up to C when writing of a previous vertex is performed.

Then, the graph data write processing unit 3093 of each server device determines whether or not the vertex value non-volatile memory write buffer 4021 has been fully filled (step S1107), and when the vertex value non-volatile memory write buffer 4021 is determined to have been fully filled (Yes in step S1107), the graph data write processing unit 3093 writes data of the vertex value non-volatile memory write buffer 4021 at that time in the non-volatile memory 405, and adds a written address of the non-volatile memory 405 to the entry of the sub group ID of the vertex value data address table 4061 (step S1108). On the other hand, when the graph data write processing unit 3093 of each server device determines that the vertex value NVM write buffer has not been fully filled (No in step S1107), the graph data write processing unit 3093 writes the vertex value in the vertex value NVM write buffer instead of the non-volatile memory 405, and the process proceeds to step S1111. In FIG. 5A, for example, when the vertex value non-volatile memory write buffer 4021 is fully filled, the graph data write processing unit 3093 writes data of the vertex value non-volatile memory write buffer 4021 in the non-volatile memory 405, and stores an address A serving as the address to the entry of the calculated local vertex ID.

Thereafter, the graph data write processing unit 3093 of each server device clears the vertex value non-volatile memory write buffer 4021 of the sub group ID (step S1109), further writes the remainder in the vertex value NVM write buffer of the sub group ID (step S1110), and adds the value of the vertex value write data amount counter of the sub group ID by the data size of the vertex value (step S1111).

The graph data write processing unit 3093 of each server device performs the same process as the process of steps S1105 to S1111 on the adjacency information. Specifically, the graph data write processing unit 30933091 of each server device adds the entry of the vertex ID to the vertex data start position table 4041, writes the value of the vertex write data amount counter 4031 of the calculated sub group ID (step S1112), and writes the adjacency information in the adjacency information non-volatile memory write buffer 4022 of the calculated sub group ID (step S1113). In FIG. 5B, for example, when the graph data write processing unit 3093 writes the adjacency information in the adjacency information non-volatile memory write buffer 4022, the graph data write processing unit 3093 stores a vertex ID “W” and a data position serving as the write start position of the vertex ID (that is, a count value of the adjacency information write data amount counter 4032) “D” in the adjacency information data start position table 4042 in association with each other. The count value “D” indicates that the sub group belongs to “2,” and the adjacency information write data amount counter 4032 is counted up to D when writing of a previous vertex is performed.

Then, the graph data write processing unit 3093 of each server device determines whether or not the adjacency information non-volatile memory write buffer 4022 has been fully filled (step S1114), and when the adjacency information non-volatile memory write buffer 4022 is determined to have been fully filled (Yes in step S1114), the graph data write processing unit 3093 writes data of the adjacency information non-volatile memory write buffer 4022 at that time in the non-volatile memory 405, and adds a written address of the non-volatile memory 405 to the entry of the sub group ID of the adjacency information data address table 4062 (step S1115). On the other hand, when the graph data write processing unit 3093 of each server device determines that the adjacency information non-volatile memory write buffer 4022 has not been fully filled (No in step S1114), the process proceeds to step S1118.

Thereafter, the graph data write processing unit 3093 of each server device clears the adjacency information non-volatile memory write buffer 4022 of the sub group ID (step S1116), further writes the remainder in the adjacency information non-volatile memory write buffer 4022 of the sub group ID (step S1117), and adds the value of the adjacency information write data amount counter 4033 of the sub group ID by the data size of the vertex value (step S1118). It is possible to execute the process of steps S1105 to S1111 and the process of steps S1105 to S1111 in parallel as illustrated in FIG. 11.

The graph data write processing unit 3093 of each server device determines whether or not reception of the graph data of all vertices allocated to the server devices has been completed (step S1119), and when the reception of the graph data of all vertices allocated to the server devices is determined to have not been completed (No in step S1119), the process returns to step S1103, and the subsequent process is repeated.

Meanwhile, when the reading of the graph data of all vertices allocated to the server devices is determined to have been completed (Yes in step S1119), the graph data write processing unit 3093 of each server device executes the following process on all the sub groups of the server devices (steps S1120 and S1123).

The graph data write processing unit 3093 of each server device generates a sub group vertex value data start position table 4051 in which the entries of the vertex IDs included in the vertex value data start position table 4041 are collected for each sub group (step S1121). Then, the graph data write processing unit 3093 of each server device writes the sub group vertex value start position table 4051 in the non-volatile memory 405, and adds an address at which the sub group vertex value data start position table 4051 of each sub group ID is written to the entry of the sub group ID of the vertex value data address table (step S1122). In FIG. 5A, for example, the graph data write processing unit 3093 divides the vertex value data start position table 4041 into sub groups for each sub group to which the vertex ID belongs using the vertex ID of the vertex value data start position table 4041 as a key with reference to the graph data illustrated in FIG. 4B, and generates the sub group vertex value data start position table 4051 in which the sub group ID, the vertex ID belonging to the sub group, and the data position are associated and collected for each sub group. As illustrated in FIG. 5A, in the sub group vertex value data start position table 4051, the sub group ID, the vertex ID of the vertex to which the sub group belongs, and the data position are associated and stored. For example, in the sub group vertex value data start position table 4051 of the sub group ID “2,” the vertex ID “V” and data positions of a plurality of vertices belonging to the sub group ID “2” starting from the data position “C” are stored. The graph data write processing unit 3093 adds the address of each sub group ID when the generated sub group vertex value start position table 4051 is written in the non-volatile memory 405 to the address list of the sub group ID of the vertex value data address table 4061. In the example illustrated in FIG. 5A, it is indicated that an address “X” of the non-volatile memory 405 is stored as the address of the sub group vertex value data start position table 5041 of the sub group ID “2.”

Further, similarly to the case of the vertex value, the graph data write processing unit 3093 of each server device executes the same process as the process of steps S1120 to S1123 on the vertex value included in the adjacency information (step S1124, S1127). Specifically, the message transmission processing unit 3091 of each server device generates a sub group adjacency information start position table 4052 in which the entries of the vertex IDs included in the adjacency information data start position table are collected for each sub group (step S1125). Then, the graph data write processing unit 3093 of each server device writes the sub group adjacency information start position table in the NVM, and adds an address at which the sub group adjacency information data start position table 4052 of each sub group ID is written to the entry of the sub group ID of the adjacency information data address table 4052 (step S1126). When the process of steps S1123 and S1127 ends, the graph data NVM writing process illustrated in FIG. 11 ends. In FIG. 5B, for example, the graph data write processing unit 3093 divides the adjacency information data start position table 4042 into sub groups for each sub group to which the vertex ID belongs using the vertex ID of the adjacency information data start position table 4042 as a key with reference to the graph data illustrated in FIG. 4B, and generates the sub group adjacency information data start position table 4052 in which the sub group ID, the vertex ID belonging to the sub group, and the data position are associated and collected for each sub group. As illustrated in FIG. 5B, in the sub group adjacency information data start position table 4052, the sub group ID, the vertex ID of the vertex to which the sub group belongs, and the data position are associated and stored. For example, in the sub group adjacency information data start position table 4052 of the sub group ID “2,” the vertex ID “W” and data positions of a plurality of vertices belonging to the sub group ID “2” starting from the data position “D” are stored. Further, the graph data write processing unit 3093 adds an address of each sub group ID when the generated sub group adjacency information start position table 4052 is written in the non-volatile memory 405 to the address list of the sub group ID of the adjacency information data address table 4062. In the example illustrated in FIG. 5B, it is indicated that an address “Y” of the non-volatile memory 405 is stored as the address of the sub group adjacency information data start position table 4052 of the sub group ID “2.”

In the graph process illustrated in FIG. 10, when the process of step S1003 ends, for all the sub groups of each server device, the process of steps S1005 to S1008 is executed (step S1004 to S1009), and the process of step S1012 is executed. The process of steps S1004 to S1009 is a process when each server device performs reading from the non-volatile memory, performs a calculation, and transmits a message, and the process of step S1012 is a process when each server device receives a message and writes the message in the non-volatile memory.

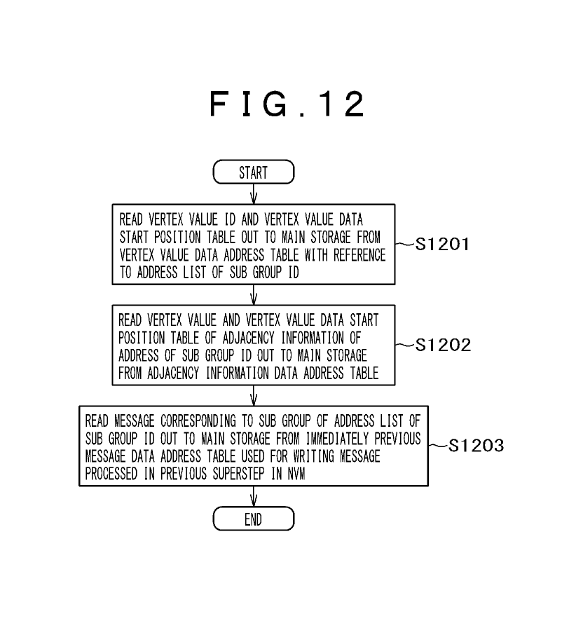

First, the message read processing unit 3094 of each server device executes a non-volatile memory reading process of step S1005. FIG. 12 is a flowchart illustrating a procedure of the non-volatile memory reading process. The message read processing unit 3094 reads the vertex value and the sub group vertex value data start position table 4051 from the non-volatile memory 405 to the main storage 310 with reference to the address list of the sub group ID in the vertex value data address table 4061 (step S1201).

Then, the message read processing unit 3094 of each server device reads the adjacency information and the sub group adjacency information data start position table 4052 from the non-volatile memory 405 to the main storage 310 with reference to the address list of the sub group ID in the adjacency information data address table (step S1202).

The message read processing unit 3094 of each server device reads a message of the address list of the sub group ID from a previous superstep message data address table 505 used for writing of a message processed in a previous superstep to the non-volatile memory 405 to the main storage 310 (step S1203). As will be described later, since the message and the local vertex ID of the sub group are associated and stored in a message non-volatile memory write buffer 5021 and the non-volatile memory 405, when the message is read from the non-volatile memory 405, the local vertex ID corresponding to the message can be known.

Since a message received in a certain superstep is used for a calculation in a next superstep, the current superstep message data address table 504 records an address at which a message is written in a superstep in which a message is received, but the previous superstep message data address table 505 stores address at which a message received in a previous superstep (that is, an immediately previous superstep) used for reading for a calculation is written. Each time a superstep is switched, the message read processing unit 3094 clears content of the previous superstep message data address table 505, and then replaces the previous step message data address table 505 with the current superstep message data address table 504. If the process of step S1203 ends, the process of step S1005 in FIG. 10 ends.

In the graph process illustrated in FIG. 10, if the process of step S1005 ends, each server device executes a sorting process of step S1006. The reason why the sorting process is performed is that the message read processing unit 3094 reads the vertex value, the adjacency information, and the message from the non-volatile memory 405 in units of sub groups, but for data (the vertex value and the adjacency information) excluding the message, as illustrated in FIGS. 5A and 5B, it is possible to know a position at which data of each vertex is present among data read in units of sub groups through each data start position table or each sub group data start position table, and in the case of the message, the messages destined for the vertices within the sub group are written without being discretely aligned.

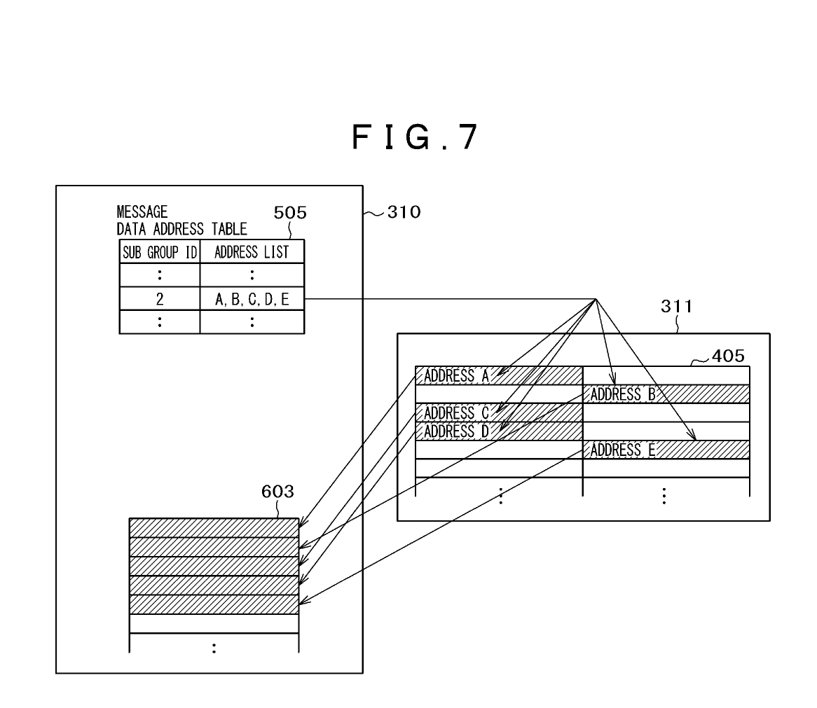

For example, as illustrated in FIG. 7, the message read processing unit 3094 reads the message of the address from the non-volatile memory 405 to a region 603 of the main storage 310 with reference to the address list corresponding to the sub group ID stored in the entire superstep message data address list 505. At this time, since the messages destined for the vertices within the sub group are written without being aligned, when the messages are extracted without change, the messages are not necessarily arranged in the right order. For this reason, it is necessary to sort and align the messages for each vertex destination before a calculation process starts. In FIG. 7, addresses of “A,” “B,” “C,” “D,” and “E” are stored in the address list corresponding to the sub group “2,” and a plurality of messages destined for the respective vertices enter data read from the respective addresses without being aligned.

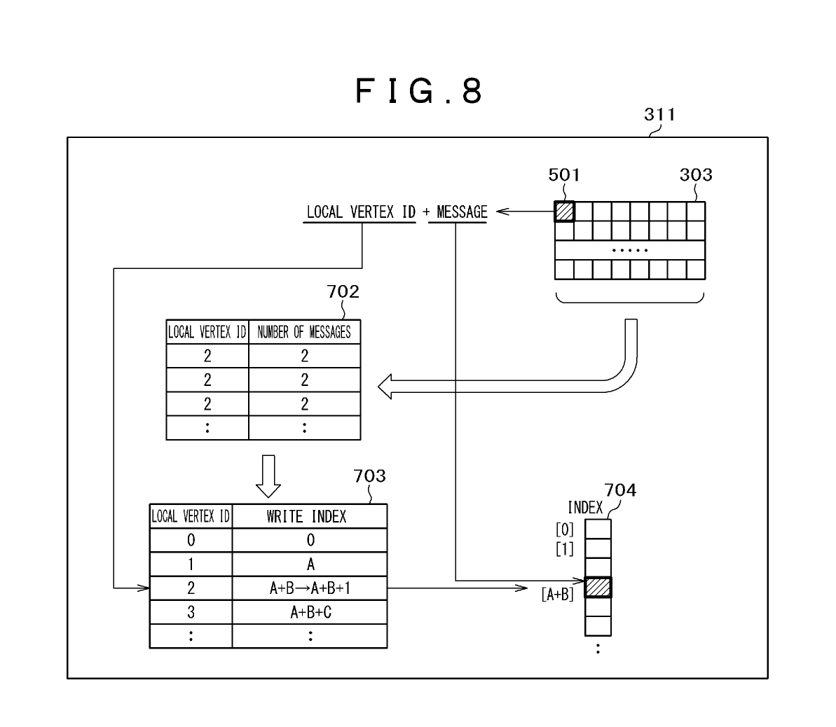

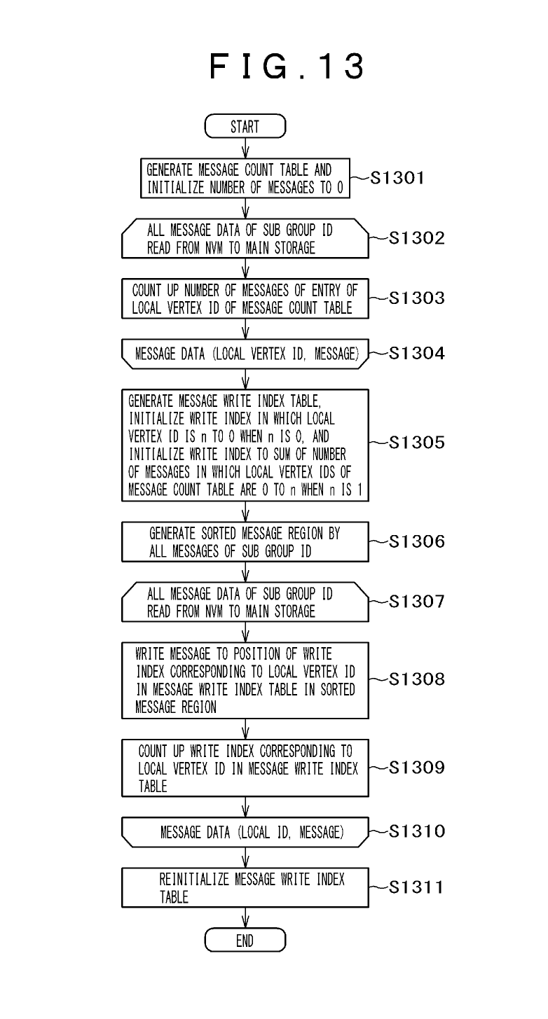

FIG. 13 is a flowchart illustrating a procedure of the sorting process. As illustrated in FIG. 13, the message read processing unit 3094 of each server device generates a message count table 702 for counting the number of messages corresponding to the local vertex ID in each sub group, and initializes the number of messages to zero (step S1301). The message count table 702 is a table for counting the number of messages included in the region 603 of the main storage 310 to which the messages of the sub group are read from the non-volatile memory 405 for each local vertex ID. For example, as illustrated in FIG. 8, it is indicated that the local vertex ID and the number of messages corresponding to the local vertex ID are associated and stored in the message count table 702, and for example, the number of messages to the local vertex ID “2” is “C.”

The message read processing unit 3094 of each server device performs the process of step S1303 on all message data of the sub group ID read from the non-volatile memory 405 to the main storage 310 (steps S1302 and S1304). In step S1303, the message read processing unit 3094 of each server device counts up the number of messages corresponding to the local vertex ID in the generated message count table 702 (step S1303).

When the number of messages of the local vertex ID is counted up, the message read processing unit 3094 of each server device generates a message write index table 703, initializes a write index in which the local vertex ID is n to 0 when n is 0, and initializes the write index to the sum of the number of messages in which the local vertex IDs of the message count table generated in step S1301 are 0 to n when n is 1 or more (step S1305). The message write index table 703 is a table for deciding a write position of a message of each local vertex ID in the main storage 310, and an initial value indicates a start position of each local vertex ID when the messages of the sub group are sorted according to the local vertex ID.

Thereafter, the message read processing unit 3094 of each server device generates a sorted message region 704 for sorting the message data according to the local vertex ID for each sub group by all messages of the sub group (step S1306), and performs the process of steps S1308 to S1309 on all message data of the sub group ID read from the non-volatile memory 405 to the main storage 310 (step S1307, S1310).

The message read processing unit 3094 of each server device writes the message at the position of the write index corresponding to the local vertex ID in the message write index table 703 in the generated sorted message region 704 (step S1308), and count up the write index corresponding to the local vertex ID in the message write index table 703 (step S1309). For example, as illustrated in FIG. 8, in the case of the message of the local vertex ID “2,” since the number of messages of the local vertices “0” and “1” are “A” and “B,” the sorting starts from a position of “A+B,” and thus an initial value of the write index is “A+B.” When the message of the local vertex ID “2” is initially written, the message is written at the position of “A+B” of the write index of the sorted message region 704, and the write index is counted up to “A+B+1.” When the message of the local ID “2” is written next, the message is written at the position of “A+B+1.” Lastly, the message read processing unit 3094 of each server device reinitializes the counted-up message write index table 703 (step S1311). When the process of step S1311 ends, the sorting process in FIG. 10 ends.

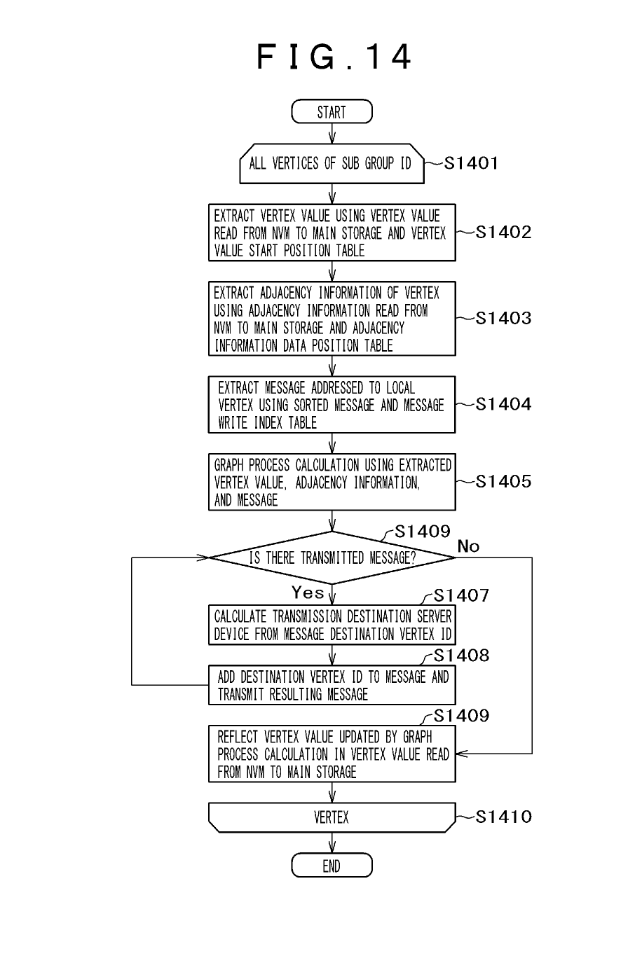

In the graph process illustrated in FIG. 10, when the process of step S1006 ends, the message read processing unit 3094 of each server device executes a calculation/message transmission process (step S1007). FIG. 14 is a flowchart illustrating a procedure of the calculation/message transmission process. As illustrated in FIG. 14, the CPU 309 of each server device performs the process of steps S1402 to S1409 on all vertices of the sub group ID (steps S1401 and S1410).

Then, the message read processing unit 3094 of each server device extracts the vertex value with reference to the vertex value data start position table 4041 using the vertex ID as a key (step S1402), similarly extracts the adjacency information with reference to the adjacency information data start position table 4042 using the vertex ID as a key (step S1403), calculates the local vertex ID from the vertex ID, and extracts the message destined for the vertex with reference to the sorted message sorted for each local vertex ID in the sorting process of FIG. 13 and the message write index table using the calculated local vertex ID as a key (step S1404).

The message read processing unit 3094 of each server device performs a graph process calculation using the extracted vertex value, the adjacency information, and the message, for example, through the technique disclosed in Non Patent Document 1 (step S1405), determines whether or not there is a message destined for the vertex (step S1406), calculates the server device of the transmission destination from the vertex ID of the destination (step S1407) when it is determined that there is the message (Yes in step S1406), and adds the destination vertex ID to the message and transmits the resulting message to the server device of the transmission destination (step S1408). Further, when the server device or the local vertex ID is calculated from the vertex ID, the message read processing unit 3094 calculates the server device or the local vertex ID based on the correspondence relation of the vertex ID, the server device, and the local vertex ID illustrated in FIG. 4B.

Meanwhile, when it is determined that there is no message destined for the vertex (No in step S1406), the message read processing unit 3094 of each server device reflects the vertex value updated by the graph process calculation in the vertex value read from the non-volatile memory 405 to the main storage 310 in step S1201 (step S1409). When the process of step S1409 ends, the process of step S1007 in FIG. 10 ends.

Then, the message read processing unit 3094 of each server device writes the vertex value read from the non-volatile memory 405 to the main storage 310 in step S1201 back to the non-volatile memory 405 (step S1008), and notifies all the server devices 302 to 305 of the process in one superstep has ended (step S1010). Upon receiving this notification from all the server devices 302 to 305, the CPU 309 of the server devices 302 to 305 clears content of the previous superstep message data address table 505, replaces the previous step message data address table 505 with the current superstep message data address table 504, determines whether or not the graph process has ended as all the supersteps have ended (step S1011), and ends the process without change when the graph process is determined to have ended (Yes in step S1011). On the other hand, when the graph process is determined to have not ended (No in step S1011), the process returns to step S1004, and the subsequent process is repeated.

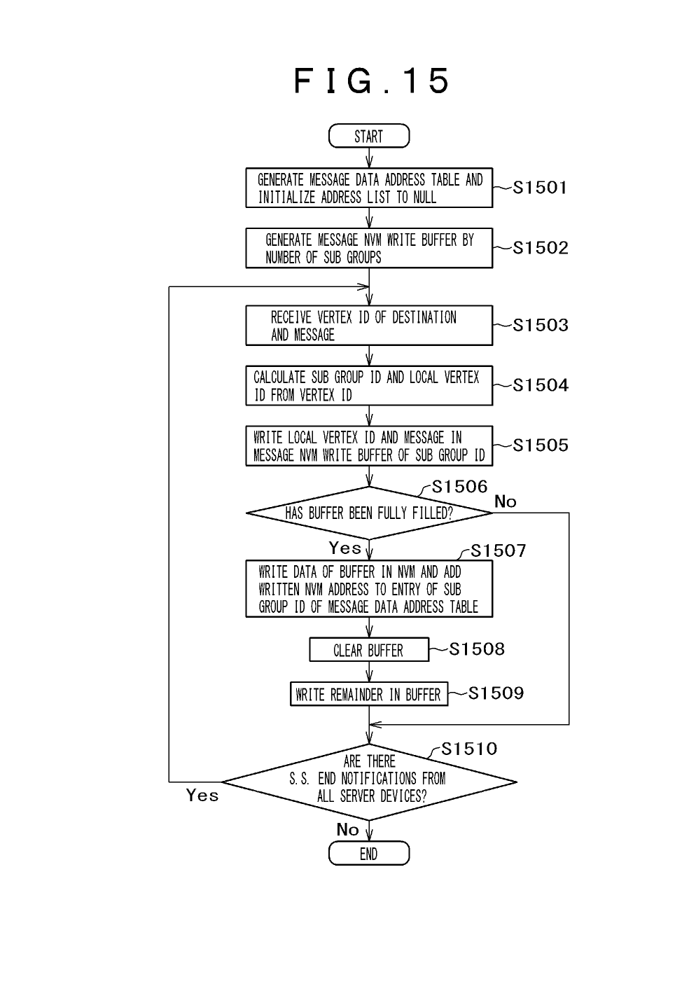

Meanwhile, when the process of step S1003 ends, the message write processing unit 3095 of each server device also executes the process of step S1012 (the message reception/NVM writing process). FIG. 15 is a flowchart illustrating a procedure of the message reception/NVM writing process. As illustrated in FIG. 15, the message write processing unit 3095 of each server device first generates the message write data address table (the current superstep message data address table 504) and the message read data address table (the previous superstep message data address table 505), and initializes the address list included in the table to a null value (step S1501).

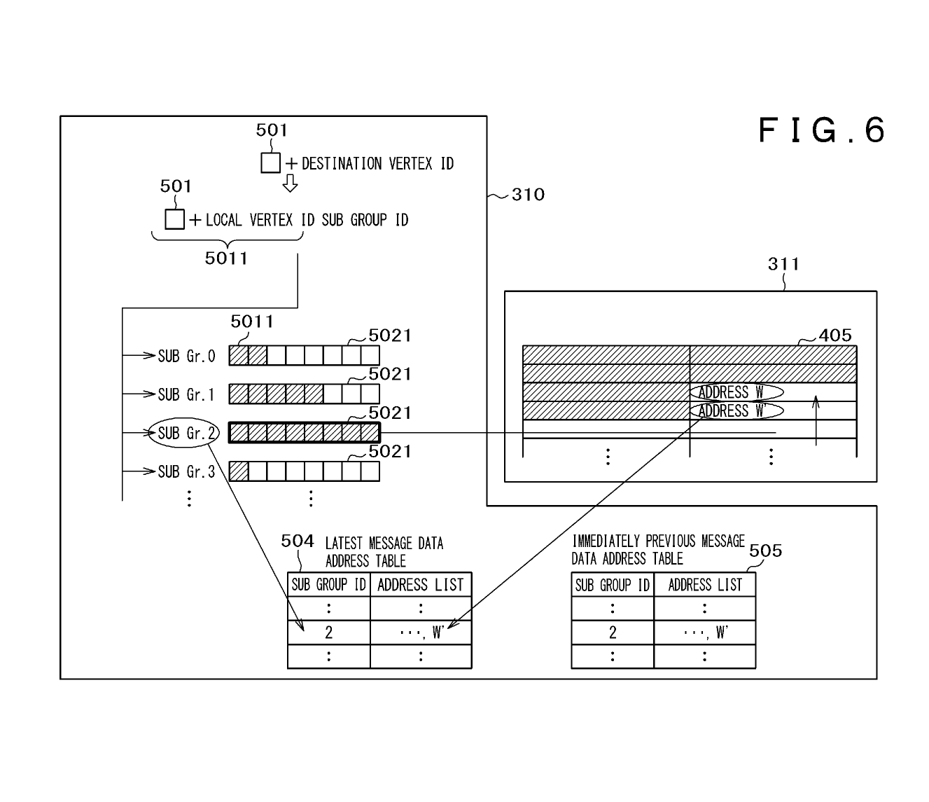

Further, the message write processing unit 3095 of each server device generates the message non-volatile memory write buffer (the message non-volatile memory write buffer 5021) by the number of sub groups (step S1502), and receives a set of the destination vertex ID and the message (step S1503). The message write processing unit 3095 of each server device calculates the sub group ID and the local vertex ID from the destination vertex ID based on the correspondence relation of the vertex ID, the server device, and the local vertex ID illustrated in FIG. 4B (step S1504), and writes the local vertex ID and the message in the message non-volatile memory write buffer 5021 of the sub group ID (step S1505). For example, as illustrated in FIG. 6, the message write processing unit 3095 generates the message non-volatile memory write buffer 5021 of the page size by the number of sub groups. Then, the message write processing unit 3095 receives a message 501 and the destination vertex ID thereof, calculates the sub group ID and the local vertex ID from the destination vertex ID, adds the local vertex ID to the message 501, and writes the resulting message 501 in the message non-volatile memory write buffer 5021 of the sub group ID to which the destination vertex ID belongs. In FIG. 6, it is indicated that for example, a set 5011 of a certain message and a local vertex ID is written in the message non-volatile memory write buffer 5021 of the sub group 2 (sub Gr.2).

The message write processing unit 3095 of each server device determines whether or not the message non-volatile memory write buffer 5021 of the sub group ID has been fully filled (step S1506), and when the message non-volatile memory write buffer 5021 of the sub group ID is determined to have been fully filled (Yes in step S1506), the message write processing unit 3095 of each server device writes the message non-volatile-memory write buffer 5021 at that time in the non-volatile memory 405, and adds the written address of the non-volatile memory 405 to the entry of the sub group ID included in the current superstep message data address table 504 (step S1507). On the other hand, when the vertex value NVM write buffer is determined to have not been fully filled (No in step S1506), the CPU 309 of each server device proceeds to step S1510. For example, in FIG. 6, the sub group ID and the address list indicating the written address of the non-volatile memory 405 are associated and stored in the current superstep message data address table 504, and a plurality of write positions starting from the write position “W” in the non-volatile memory 405 are stored in the address list in which the sub group ID is “2.”

Thereafter, the message write processing unit 3095 of each server device clears the message non-volatile memory write buffer 5021 of the sub group ID (step S1508), and writes the remainder in the message non-volatile memory write buffer 5021 of the sub group ID (step S1509). Then, the message write processing unit 3095 of each server device determines whether or not the process in the superstep has ended in all the server devices (step S1510), and when the process in the superstep is determined to have not ended in any one of the server devices (No in step S1510), the process returns to step S1503, and the subsequent process is repeated. On the other hand, when the process in the superstep is determined to have ended in all the server devices (Yes in step S1510), the message write processing unit 3095 of each server device ends the message reception/NVM writing process illustrated in FIG. 15.

When the process of step S1012 of FIG. 10 ends, the message write processing unit 3095 of each server device determines whether or not the graph process has ended (step S1013), and when the graph process is determined to have not ended (No in step S1013), the process of step S1012 is repeated until the graph process ends, whereas when the graph process is determined to have ended (Yes in step S1013), the graph process illustrated in FIG. 10 ends.

As the graph process using the BSP model is performed as described above, it is possible to perform all access to the non-volatile memory in units of page sizes while storing the graph data and the message in the non-volatile memory, and it is possible to efficiently perform access to the non-volatile memory without causing random access having fine granularity to occur frequently. In other words, data necessary for a calculation in the graph process is the graph data (the value of the vertex and the adjacency information (an ID of a vertex connected with the vertex by an edge and a value of the edge) and data of the message destined for the vertex, but since the data around one vertex is smaller than the page size, a plurality of vertices are collectively defined as a vertex group, the calculation of the graph process is performed in units of vertex groups, and the vertex group is defined so that data necessary for a calculation of a vertex group is sufficiently larger than the page size, and thus it is possible to arrange data necessary for a calculation of the vertex group on the non-volatile memory in units of page sizes, and it is possible to use the page size as the granularity of access to the non-volatile memory and suppress a decrease in performance of the non-volatile memory access.

Further, the present embodiment has been described in connection with the example in which the message is transmitted in the example of the graph process using the BSP model but can be also applied to a shuffling phase and a sorting phase in which a total amount of a key-value pair generated in a mapping phase in MapReduce per one of the server devices 302 to 305 is larger than the size of the main storage 310.

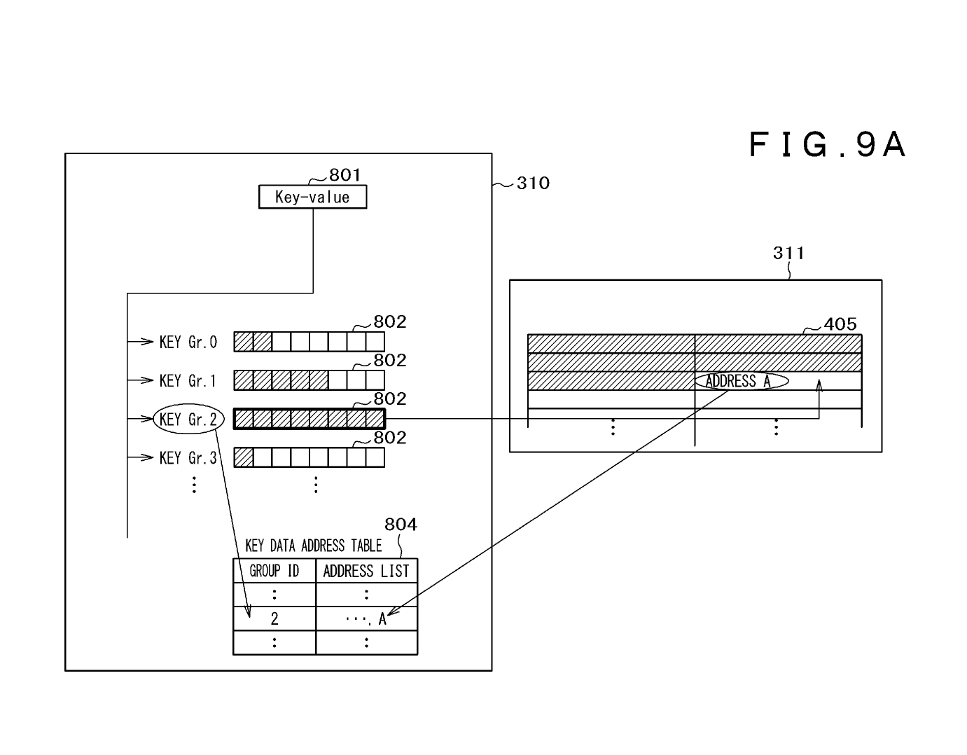

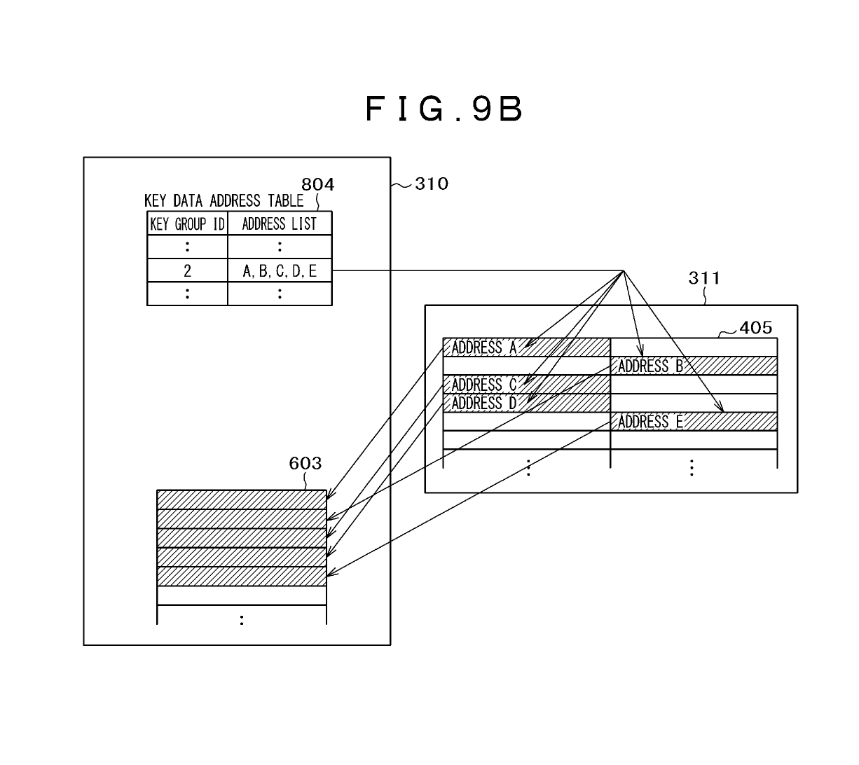

In the shuffling phase, the message read processing unit 3094 of each server device receives the key-value pair generated in the mapping phase, and writes the key-value pair in the non-volatile memory 405. A method of writing the key-value pair in the non-volatile memory 405 is illustrated in FIG. 9A. First, the preprocessing unit 3091 collects a plurality of keys and defines a key group. The number of values included in the key group is set so that a total amount of the key-value pair included in the key group is sufficiently larger than the page size of the non-volatile memory 311 and smaller than the capacity of the main storage 310.

Similarly to the example illustrated in FIG. 6, the message write processing unit 3095 generates a non-volatile memory write buffer 802 of the page size by the number of key groups, and writes a key-value pair 801 in the non-volatile memory write buffer 802 of the key group to which the key belongs. When the non-volatile memory write buffer 802 is fully filled, the message write processing unit 3095 writes content of the non-volatile memory write buffer 802 in a non-volatile memory 803, stores the address list indicating an address at which data of the key group is written, and records the written address in a key data address table 804. Further, when writing content of the non-volatile memory buffer 802 in the non-volatile memory 405 ends, the message write processing unit 3095 clears the non-volatile memory write buffer 802, and starts writing from the head of the buffer again. After all the key-value pairs are written in the non-volatile memory 405, the message write processing unit 3095 performs the sorting phase while reading the key-value pair from the non-volatile memory 405.

A method of reading the key-value pair from the non-volatile memory in the sorting phase is illustrated in FIG. 9B. The message write processing unit 3095 selects one key group from the key data address table 804 generated in the shuffling phase, and reads data of the key-value pair from the non-volatile memory 405 to a main storage 603 based on the address list. The message write processing unit 3095 sorts the data read to the region 603 of the main storage 310, and transfers the data to a reducing phase. When the reducing process of the key group ends, the message write processing unit 3095 selects another key group and repeats the same process.

As the shuffling phase and the sorting phase are performed as described above, when a total amount of the key-value pair generated in the mapping phase per one of the server devices 302 to 305 is larger than the size of the main storage 310, the shuffling process and the sorting process using the non-volatile memory can be performed while performing all access to the non-volatile memory in units of page sizes.

The present invention is not limited to the above embodiment, and includes various modified examples. For example, the above embodiment has been described in detail in order to help understanding with the present invention, and the present invention is not limited to a configuration necessarily including all components described above. Further, some components of a certain embodiment may be replaced with components of another embodiment, and components of another embodiment may be added to components of a certain embodiment. In addition, another component can be added to, deleted from, or replaced with some components of each embodiment.

### REFERENCE SIGNS LIST

101 Vertex
102 Edge
301 Information processing system
302 to 305 Server devices
306 Shared storage device
307 Network
308 Storage area network
309 CPU
3091 Preprocessing unit
3092 Graph data read processing unit
3093 Graph data write processing unit
3094 Message read processing unit
3095 Message write processing unit
310 Main storage
311 Non-volatile memory
312 Network interface
313 Storage network interface
4011 Vertex value
4012 Adjacency information
4021 Vertex value non-volatile memory write buffer
4022 Adjacency information non-volatile memory write buffer
4031 Vertex value write data amount counter
4032 Adjacency information write data amount counter
4041 vertex value data start position table
4042 Adjacency information data start position table
405 Non-volatile memory writing region
4051 Sub group vertex value data start position table
4052 Sub group adjacency information data start position table
4061 Vertex value data address table
4062 Adjacency information data address table
501 Message
5011 Set of message and local vertex ID
502 Message non-volatile memory write buffer
504 Current superstep data address table
505 Previous superstep data address table
603 Read region from non-volatile memory to main storage
702 Message count table
703 Message write index table
704 Sorted message region
801 Key-value pair
802 Non-volatile memory write buffer
804 Key the data address table

1. An information processing system that causes an information processing apparatus including a main storage unit and a storage unit capable of reading and writing data including an identifier in predetermined units to collect and process the data by a predetermined amount,
wherein the information processing apparatus includes
a preprocessing unit that allocates the identifier to one or more collected groups,
the main storage unit including a buffer having a size of the predetermined unit installed for each group,
the storage unit that stores the data written in the buffer for each predetermined unit and each group,
a write processing unit that acquires the data allocated to the group for each group and writes the acquired data in the buffer, determines whether or not the data of the predetermined unit has been written in the buffer, and causes the storage unit to store the data written in the buffer when the data of the predetermined unit is determined to have been written in the buffer, and
a read processing unit that reads the stored data out to the main storage unit for each group, extracts the read data, and executes the process.

2. The information processing system according to claim 1,
wherein in the information processing system, a plurality of information processing apparatuses are connected to one another via network,
each of the information processing apparatuses stores the data in association with the information processing apparatus that processes the data,
the data that has undergone the process performed by the read processing unit is transmitted to another information processing apparatus via the network, and
the other information processing apparatus includes a write processing unit that receives the data that has undergone the process, writes the received data in the buffer, determines whether or not the data of the predetermined unit has been written in the buffer, and causes the storage unit to store the data written in the buffer when the data of the predetermined unit is determined to have been written in the buffer.

3. The information processing system according to claim 1,
wherein the storage unit is configured with a non-volatile memory.

4. The information processing system according to claim 3,
wherein the predetermined amount is the same size as a minimum write unit of the non-volatile memory.

5. The information processing system according to claim 1,
wherein the data including the identifier is graph data in a graph process, and the identifier is a vertex ID identifying a vertex of a graph.

6. The information processing system according to claim 5,
wherein the data including the identifier further includes message data between vertices in the graph process, and the identifier is a vertex ID identifying a vertex of a graph.

7. A data processing method that is performed by an information processing system that causes an information processing apparatus including a main storage unit and a storage unit capable of reading and writing data including an identifier in predetermined units to collect and process the data by a predetermined amount, the data processing method comprising:
an allocation step of allocating the data serving as a target of the process to a group collected in the predetermined amount;
a transmission and writing step of acquiring the data allocated to the group for each group and writing the acquired data in a buffer having a size of the predetermined unit installed for each group;
a transmission determination step of determining whether or not the data of the predetermined unit has been written in the buffer;
a write processing step of causing the storage unit that performs storage for each predetermined unit and each group to store the data written in the buffer when the data of the predetermined unit is determined to have been written in the buffer; and
a read processing step of reading the stored data out to the main storage unit for each group, extracting the read data, and executing the process.

8. The data processing method according to claim 7,
wherein in the information processing system, a plurality of information processing apparatuses are connected to one another via network,
in the allocation step, the data is allocated for each information processing apparatus that processes the data and each group, and
when the read processing step is executed, the data processing method further comprises:
a transmission step of transmitting the data that has undergone the process to another information processing apparatus via the network;
a reception writing step of receiving, by the other information processing apparatus, the data that has undergone the process and writing the received data in the buffer;
a reception determination step of determining whether or not the data of the predetermined unit has been written in the buffer; and
a reception storage step of causing the storage unit to store the data written in the buffer when the data of the predetermined unit is determined to have been written in the buffer.
